(19) United States
(12) Patent Application Publication
(10) Pub. No.: US 2025/0325438 A1
(43) Pub. Date: Oct. 23, 2025

(54) SKIN TREATMENT TOOL

(71) Applicants: Danielle Logan, Aliso Viejo, CA (US); David Poer, Laguna Hills, CA (US)

(72) Inventors: Danielle Logan, Aliso Viejo, CA (US); David Poer, Laguna Hills, CA (US)

(21) Appl. No.: 19/184,797

(22) Filed: Apr. 21, 2025

Related U.S. Application Data
(60) Provisional application No. 63/636,679, filed on Apr. 19, 2024.

(51) Int. Cl. A61H 15/00; A61H 9/00

(52) U.S. Cl. CPC A61H 15/0092; A61H 9/005; A61H 2009/0064; A61H 2015/0021; A61H 2015/0035; A61H 2201/1253; A61H 2201/1454; A61H 2201/1673; A61H 2201/1688; A61H 2201/1695; A61H 2207/00

(57) ABSTRACT

Disclosed are devices, systems and methods for softening fascia and/or performing mini cupping to increase blood flow to surface and subsurface anatomical structures, including a tool which employs a rotatable hub having a combination of small suction cups and mechanical compression elements positioned thereon.

### FIELD OF THE INVENTION

The disclosed devices, system and methods relate to tool and techniques for manipulating surface/subsurface tissues and/or softening/loosening fascia and/or increasing blood flow to an area of a patient's body. More specifically, disclosed is a tool which is useful for contacting and molding body tissues, such as by visibly smoothing subsurface cellulite in a patient's body.

### BACKGROUND OF THE INVENTION

This section provides background information related to the present disclosure which is not necessarily prior art.

In cryotherapy, various machines and medical instruments can be utilized to reposition, remove, damage and/or alter a patient's fat cells. In many instances, a patient may request removal and/or “sculpting” of their cellulite. While invasive methods of altering and/or removing adipose tissue and/or fat cells is available via liposuction and/or other plastic surgery, such procedures are expensive and carry a significantly increased risk of infection, nerve damage, and contour irregularities (e.g., lumps and/or dents). Such procedures also require a recovery period with associated pain, swelling, and bruising. In addition, liposuction doesn't address issues like loose skin or cellulite.

It is estimated that between 80% and 90% of women have unwanted cellulite, and unwanted cellulite can also be a significant concern for men. Cellulite can be readily apparent on a skinny person, a fat person, a fit person, and/or an old or a young person. In many cases, unwanted cellulite is related to an individual's self-image, which is often more about an individual's perceptions rather than size and weight. Many people are still learning what the actual cause of cellulite is as well as better ways to treat it. There have been many creams and lotions and rollers made available to help minimize the appearance of cellulite. There are also invasive treatments and surgeries to internally pull or cut the fascia to loosen it to help reduce the appearance of cellulite. These invasive treatments have a large risk to create more scar tissue in the area potentially making the problem worse in the long run.

Accordingly, there is a need for safer and/or lower cost devices and methods for manipulating and/or sculpting surface and/or subsurface tissues of patients, and the present subject matter is such improvement.

### BRIEF SUMMARY OF THE INVENTION

The following presents a simplified summary of the subject matter in order to provide a basic understanding of some aspects of the subject matter. This summary is not an extensive overview of the subject matter. It is intended to neither identify key or critical elements of the subject matter nor delineate the scope of the subject matter. Its sole purpose is to present some concepts of the subject matter in a simplified form as a prelude to the more detailed description that is presented later.

Further areas of applicability will become apparent from the description provided herein. The description and specific examples in this summary are intended for purposes of illustration only and are not intended to limit the scope of the present disclosure.

In accordance with various aspects of the present subject matter, systems, devices and/or methods are disclosed which may be useful in sculpting surface and/or subsurface tissues of patients. The present technology includes articles of manufacture, systems, and processes that relate thereto.

The disclosed device(s) can be utilized by rolling the device over a patient's skin externally. The handles desirably facilitate the rolling motion and sliding of the device over and/or along the skin. The roller can be used up and down and/or side to side, as well as various combinations thereof. The disclosed treatment can be used all over the body, which can desirably help to soften fascia and/or redistribute/sculpt cellulite and/or other underlying tissues.

If desired, the various systems and/or components described herein could comprise a variety of modular components. If desired, such modular components could be provided in a kit form for selection and/or assembly in a work area or other location. If desired, various components may be removable, replaceable and/or washable/recyclable.

The following description and the annexed drawings set forth in detail certain illustrative aspects of the subject matter. These aspects are indicative, however, of but a few of the various ways in which the principles of the subject matter may be employed and the present subject matter is intended to include all such aspects and their equivalents. Other objects, advantages and novel features of the subject matter will become apparent from the following detailed description of the subject matter when considered in conjunction with the drawings

### BRIEF DESCRIPTION OF THE SEVERAL VIEWS OF THE DRAWINGS

The foregoing and other features and advantages of the present subject matter will become apparent to those skilled in the art to which the present subject matter relates upon reading the following description with reference to the accompanying drawings.

FIG. 1 is a perspective view of one exemplary embodiment of a skin treatment device;

FIGS. 2A through 2C depict an exemplary roller hub portion of the skin treatment device of FIG. 1;

FIG. 2D depicts a side view of the roller hub of FIG. 2A, showing alternating nubs and suction cups being attached to prongs and tabs on the hub;

FIGS. 3A through 3C depict various views of a handle body;

FIG. 4A depicts a roller shaft having a central shaft section and threaded ends;

FIG. 4B depicts the threaded ends of the roller shaft of FIG. 4A connected to threaded portions of handle bodies;

FIGS. 5A through 5C depict various views of one embodiment of a nub for attachment to an outwardly extending prong of the roller hub of FIG. 2A;

FIGS. 6A through 6D depict various views of one embodiment of a thrust bearing assembly;

FIGS. 7A through 7C depict various views of one embodiment of a suction cup for attachment to an outwardly extending tab of the roller hub of FIG. 2A; and

FIG. 8 depicts a perspective view of another embodiment of a skin treatment device.

### DETAILED DESCRIPTION OF THE INVENTION

The following description and the annexed drawings set forth in detail certain illustrative aspects of the subject matter. These aspects are indicative, however, of but a few of the various ways in which the principles of the subject matter may be employed and the present subject matter is intended to include all such aspects and their equivalents. Other objects, advantages and novel features of the subject matter will become apparent from the following detailed description of the subject matter when considered in conjunction with the drawings.

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including,” “comprising” and variations thereof, as used in this disclosure, mean “including, but not limited to,” unless expressly specified otherwise. The terms “a,” “an,” and “the,” as used in this disclosure, mean “one or more,” unless expressly specified otherwise.

Devices and/or device components that are disclosed in communication with each other need not necessarily be in continuous communication with each other, unless expressly specified otherwise. In addition, devices that are in direct contact with each other may contact each other directly or indirectly through one or more intermediary articles or devices.

Although process steps, method steps, or the like, may be described in a sequential order, such processes and methods may be configured in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device or article may be alternatively embodied by one or more other devices or articles which are not explicitly described as having such functionality or features.

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The present technology desirably provides a low cost, safe and easily utilized device for manipulating and/or sculpting surface and/or subsurface tissues of patients.

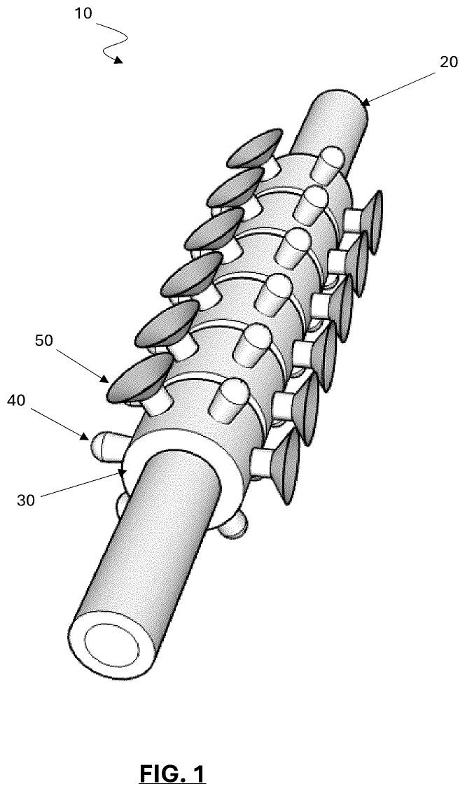

FIG. 1 depicts one exemplary embodiment of a skin treatment device 10 constructed in accordance with various teachings of the present invention. The device 10 includes a central handle 20 which can be easily gripped by a user. A series of roller hubs 30 are rotatably mounted to the handle 30, with each of the roller hubs 30 desirably incorporating a plurality of nubs 40 and cups 50 arranged around the periphery of the roller hub 30. In this embodiment, the nubs 40 are arranged at 0, 120 and 240 degree positions about the periphery, with the cups 50 arranged at 60, 180 and 300 degree positions about the periphery (although various other positions and/or arrangements for the nubs and cups are contemplated herein, including positions at various other angles and/or the employment of more or fewer nubs/cups on a single roller hub). The nubs 40 and the cups 50 desirably alternate about the periphery of each roller hub 30.

As shown, the device 10 includes 6 (six) individual roller hubs 30, which are spaced along and desirably rotatably mounted to the handle 20. In the disclosed embodiment, each of the roller hubs 30 are desirably mounted to allow individual rotation of a single roller hub relative to the handle as well as the remaining roller hubs of the device. In alternative embodiments, the roller hubs may be fixed to the handle and/or each other in any combination of arrangements understood by those of skill in the art. Similarly, differing numbers of roller hubs may be provided on a device, depending upon user preferences and/or desired application.

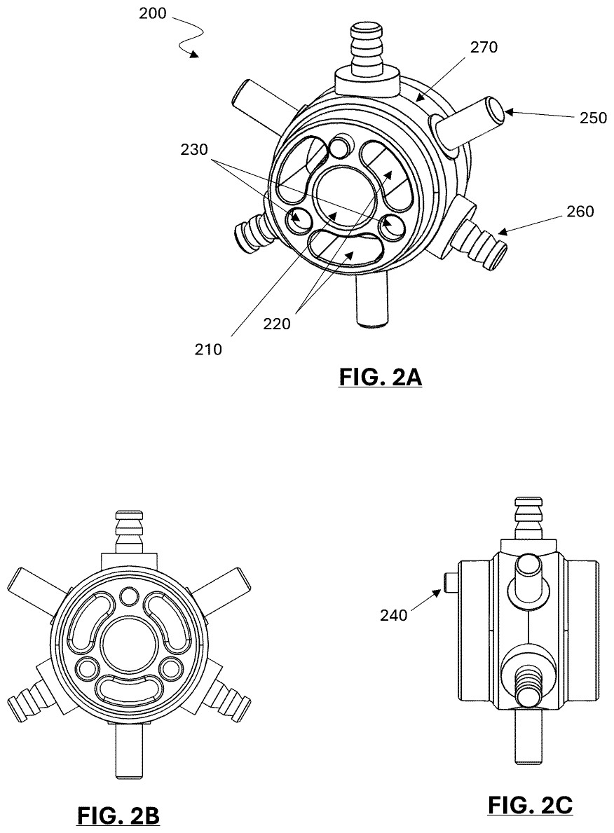

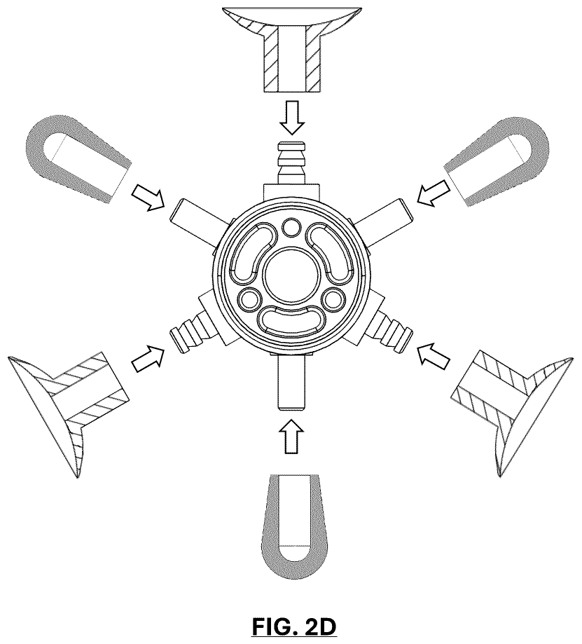

FIGS. 2A through 2C depict an exemplary roller hub 200. The hub desirably includes a central shaft opening 210, one or more elongated side pockets 220, one or more side openings 230 and, optionally, at least one laterally extending tine 240. A series of outwardly extending prongs 250 and tabs 260 are provided on the outer circumference 270 of the hub 200. As best seen in FIG. 2D, the prong and tabs will desirably accommodate and be attached to alternating nubs and suction cups. In various embodiments, the optional tine 240 can be positioned within one or more of the elongated side pockets 220 or one of the side openings of an adjacent roller hub to desirably restrict relative rotation between the roller hubs in various fashions. For example, if a tine is positioned within a side opening of an adjacent roller hub, then the two roller hubs would be constrained to rotate with each other in a revolute pair. As an alternative arrangement, if a tine was positioned within an elongated side pocket of an adjacent roller hub, then the rotation of the two roller hubs could potentially differ to the extent that the tine could slide within the elongated pocket during roller rotation. By constraining the tine within a side pocket/side opening of an adjacent roller hub, roller motion can desirably be induced for hubs which may not be in direct contact (via their respective nubs and/or cups) with a patient's anatomy.

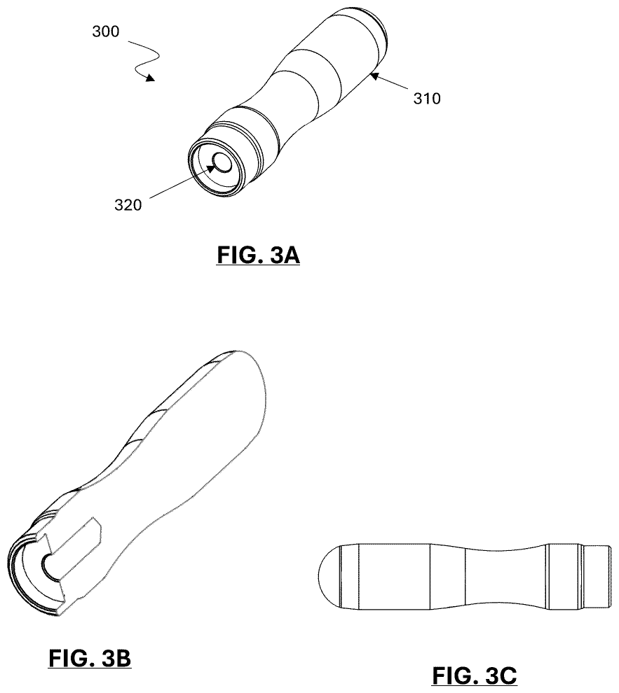

FIGS. 3A through 3C depict various views of a handle body 300. The handle body 300 desirably includes an outer surface 310 which can be grasped by a user's hands, along with a central opening 320 which can be internally threaded (not shown).

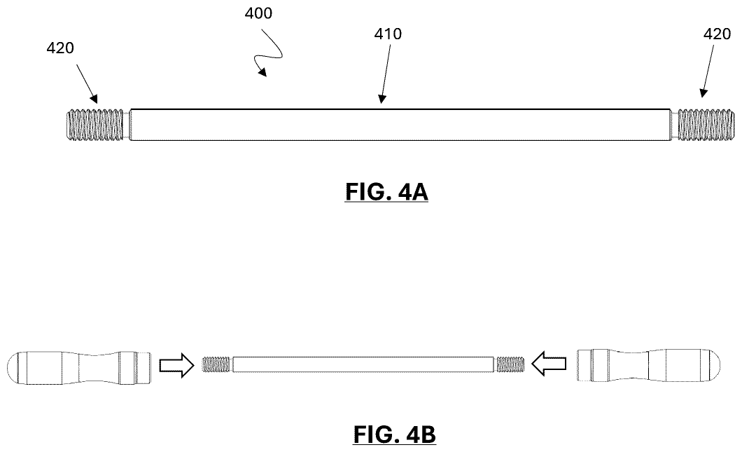

FIG. 4A depicts a roller shaft 400 having a central shaft section 410 and threaded ends 420. As best seen in FIG. 4B, the threaded ends can accommodate the threaded portions of the handle bodies during assembly of the device. Desirably, the central shaft openings of a plurality of roller hubs can be slid over the central shaft section 410, with the handle bodies attached to each end of the roller shaft 400.

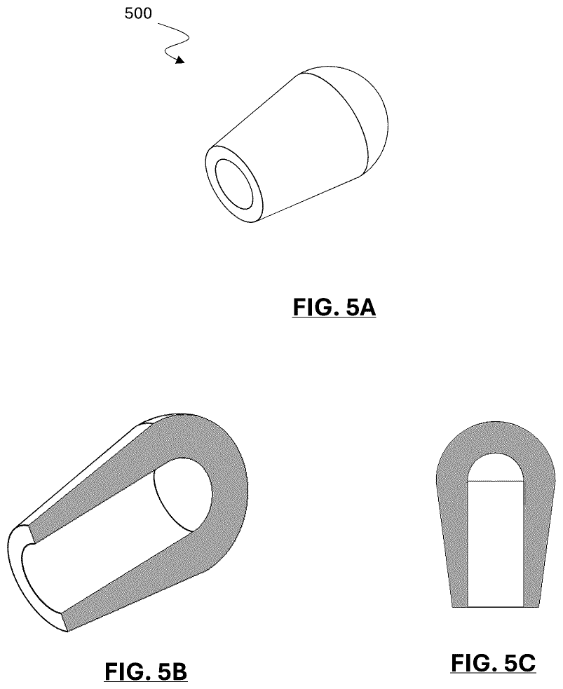

FIGS. 5A through 5C depict various views of one embodiment of a nub 500 for attachment to an outwardly extending prong of a roller hub. As shown, the nub can comprise a relatively hard and/or rigid plastic material. An opening in a base of the nub will desirably slide over the outwardly extending prong of a roller hub, and may be secured via a press fit and/or other attachment method (i.e., adhesives, thermal bonding, friction fit, threaded engagement) known to those skilled in the art.

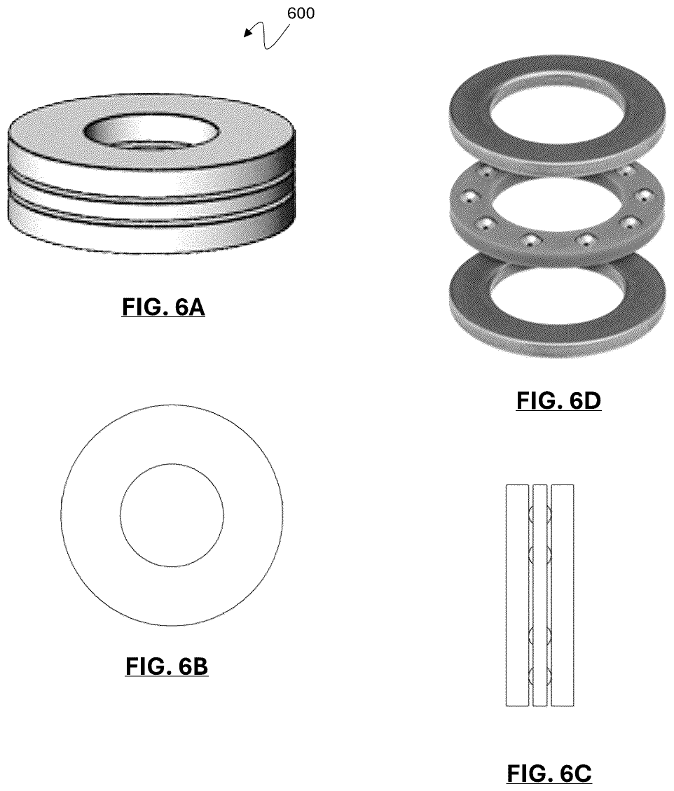

FIGS. 6A through 6D depict various views of one embodiment of a thrust bearing 600 for attachment to an outwardly extending prong of a roller hub which can be positioned between an end hub and the handle bodies of the device (and/or can be positioned between individual roller hubs). The thrust bearing will desirably facilitate rotation of the hub around the central shaft section while engaging with the handle bodies. One exemplary commercially available thrust bearing useful in the present invention is Thrust Ball Bearing Part Number 6655K35 (commercially available from McMaster Carr Supply Company of Santa Fe Springs, CA, USA).

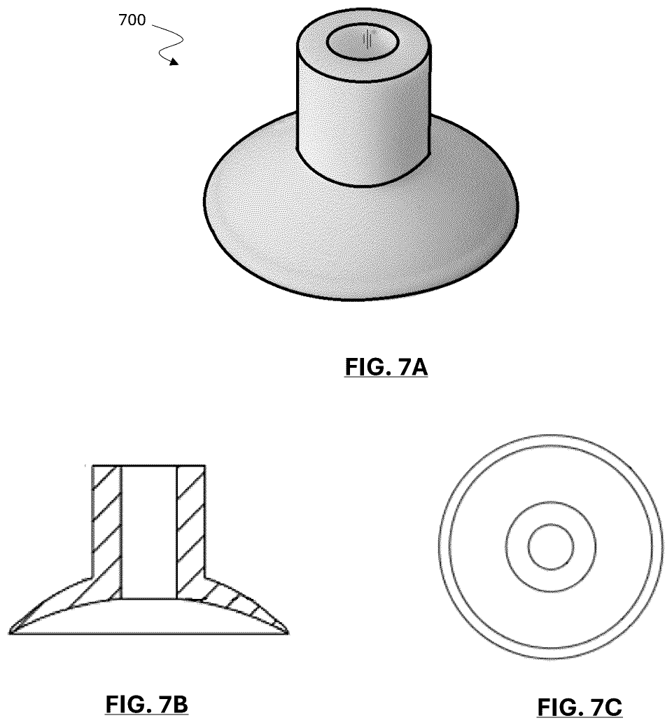

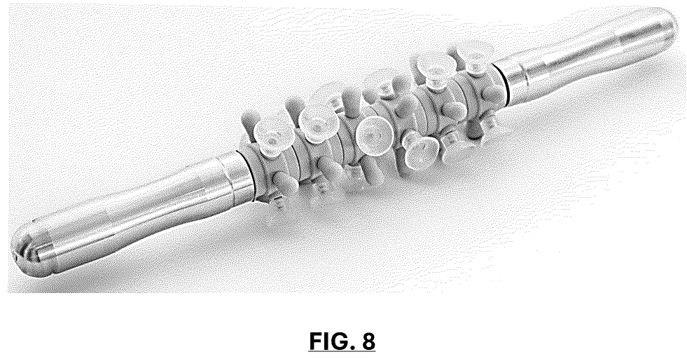

FIGS. 7A through 7C depict various views of one embodiment of a suction cup 700 for attachment to an outwardly extending tab of a roller hub. As shown, the cup can comprise a relatively flexible material such as silicone or rubber. An opening in a base of the cup will desirably slide over the outwardly extending tab of a roller hub, and may be secured via friction fit and/or other attachment methods (i.e., adhesive, thermal bonding, threaded engagement) known to those skilled in the art. One commercially available suction cup useful in the present invention is a 20 mm flat suction cup, FDA Silicone Item Number 10F.020.004.02 (commercially available from VacMotion Inc. of Plymouth, MA, USA).

FIG. 8 depicts a perspective view of another exemplary embodiment of a skin treatment device constructed in accordance with various teachings of the invention.

Various components of the disclosed tool can include cups, nubs and/or fingers that can be permanently mounted to the roller hub, or alternatively modular cups, nubs and/or fingers may removed and/or replaced and/or otherwise positioned on extensions, tabs or prongs that extend outward from a hard plastic roller hub. If desired, modular cups and/or fingers can be placed in a variety of positions and/or distributions around the hub, per the user's preference. In various embodiments, the roller can comprise a plurality of individual cylindrical roller sections, with each section capable of rotating independent of other sections. In one exemplary embodiment, a skin treatment tool can comprise six independently rotating roller sections having cups and/or fingers thereupon, although alternative tools having a single roller section as well as 2, 3, 4, 5, 7, 8, 9, 10 and/or more independent roller sections are contemplated herein. Similarly, roller hubs can incorporate three cups and three nubs, as described herein, or alternatively can include varying other arrangements and/or numbers of hubs and/or cups.

In various embodiments, the disclosed device can be utilized by rolling the device over a patient's skin externally, with the suction cups deforming and “sucking to” the skin tissues as they press downward on the tissue and are subsequently rotated away from the tissue (e.g., manually operated suction cups). The handles desirably facilitate such rolling motion and sliding of the device over and/or along the skin. The roller can be used up and down and/or side to side, as well as various combinations thereof. The disclosed treatment can be used all over the body, which can desirably help to soften fascia and/or redistribute/sculpt cellulite and/or other underlying tissues. Various areas can be targeted with treatment, including the legs, buttocks, arms, and/or tummy areas. Depending on the user holds the device, the user may manipulate the device to provide increased tissue pressure from the fingers/nubs and/or the user may push the roller over a targeted area and/or the user may lightly roll the device over an area, which can desirably focus on cupping the skin surface at the same time as targeting the fascia and/or underlying tissues. Rolling the device from different directions can also be helpful in various instances.

In various embodiments, there can be two 2 modalities which the device utilizes to optimize treatment results. A first modality is the relatively harder, pear-shaped nubs or “fingers” throughout the roller which contact the tissue surface and desirably target the tight fascia and/or underlying tissues. Unlike simply rolling a flat surface over fascia, the disclosed nubs or fingers provide an increased pressure “point” which compresses the skin surface and pushes downward get deep into the fascia to essentially dig into it to manipulate, loosen and/or soften these deeper tissues. The second modality is the softer, flexible suction cups, which tend to adhere to the tissue and draw it outward as the device advances, providing a “cupping” therapy which is intended to increase localized blood flow and facilitate the purging and/or drainage of excess fluids and toxins from the targeted tissue region. Desirably, the disclosed device provides a method of mini dry cupping, which uses the compression and release of the suction cups as the hubs rotate to provide a “pumping method” to the skin, which draws the skin tissue inside the cup and then releases it once the cup is rotated away from the tissue surface. This suction can create a negative pressure environment as opposed to the direct pressure of the nubs; which negative pressure desirably lifts underlying muscle fibers and increases blood flow to the treated area. In many instances, the main causes of cellulite and/or unhealthy tissues can be tight, unhealthy fascia and poor blood circulation. Blood flows directly with fascia and they both play a very important part in the manipulation, management and/or appearance of cellulite. Healthy blood flow and fascia can lead to smooth skin and unhealthy blood flow and fascia can lead to dimpled, lumpy looking skin.

The disclosed dual treatment mechanism of the device and methods described herein will desirably provide patients with maximal results. Desirably, the fingers will massage and/or help to soften the fascia, while the suction cups will help increase the blood flow to the area. The disclosed roller device targets the root of the problem in a non-invasive and productive way. By targeting the root of the problem, the results are smoother, tighter looking skin. When softening the fascia and increasing the blood flow to an area, the disclosed treatments desirably create a healthier environment internally for the patient, creating less pain, less tightness, and more flexibility/movement of the treated tissues.

The disclosed combination of pressure contact and suction drawing over the skin surfaces desirably can affect the skin, muscles and/or underlying in many different ways. The nubs can provide a pressing action applied to soft tissue for therapeutic purposes, which aims to improve the metabolism of the musculoskeletal and mobile systems, relax muscle tension and maintain work ability. It can also be used for the purpose of stimulating lymph circulation, etc., to relax and stabilize tissues and treat connective tissue inflammation. Concurrently, the cups can provide a subcutaneous suction massage for fat and connective tissue to desirably stimulate metabolism and blood circulation, restore tissue tightness, and remove cellulite, swelling, and muscle tension. Desirably, the disclosed treatments may also have positive consequences for conditions resulting from connective tissue pain, scar tissue problems, sports activities, insomnia and tension.

In various embodiments, a cream or lotion may desirably be rubbed and/or otherwise applied to a patient's skin prior to treatment with the disclosed devices, which can desirably improve the suction and/or cupping ability of the modular cups, as well as soften and/or lubricate the skin.

If desired, a “kit” or other packaging could include modular components of differing shapes and/or sizes constructed from the same or a variety of different materials for assembly by a user, as well as replacement components such as additional suction cups which may “wear out” after repeated use.

In accordance with another aspect of the present subject matter, various methods for manufacturing the disclosed device and/or components thereof, as set for within any of the details described with the present application, are provided.

While embodiments and applications of the present subject matter have been shown and described, it would be apparent that other embodiments, applications and aspects are possible and are thus contemplated and are within the scope of this application.

Note that, in various alternative embodiments, variations in the position and/or relationships between the various figures and/or modular components are contemplated, such that different relative positions of the various modules and/or component parts, depending upon specific module design and/or interchangeability, may be possible. In other words, different relative adjustment positions of the various components may be accomplished via adjustment in separation and/or surface angulation of one of more of the components to achieve a variety of resulting device configurations, shapes and/or sizes, thereby accommodating virtually any expected anatomical variations.

While embodiments and applications of the present subject matter have been shown and described, it would be apparent to those skilled in the art that many more modifications are possible without departing from the inventive concepts herein. The subject matter, therefore, is not to be restricted except in the spirit of the appended claims.

All references, including publications, patent applications, and patents, cited herein are hereby incorporated by reference to the same extent as if each reference were individually and specifically indicated to be incorporated by reference and were set forth in its entirety herein.

The various headings and titles used herein are for the convenience of the reader and should not be construed to limit or constrain any of the features or disclosures thereunder to a specific embodiment or embodiments. It should be understood that various exemplary embodiments could incorporate numerous combinations of the various advantages and/or features described, all manner of combinations of which are contemplated and expressly incorporated hereunder.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., i.e., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed:

1. A skin treatment tool for smoothing skin structures of a patient, comprising:
a handle,
a first roller positioned around the handle,
the first roller having a first plurality of suction cups and a second plurality of nubs extending outward from the first roller.

2. The skin treatment tool of claim 1, wherein the first plurality of suction cups and the second plurality of nubs are evenly spaced about a perimeter surface of the first roller.

3. The skin treatment tool of claim 2, wherein the first roller is rotatably mounted to the handle so as to freely rotate around the handle.

4. The skin treatment tool of claim 3, further comprising a second roller positioned around the handle, the second roller being longitudinally spaced apart from the first roller, the second roller having a second plurality of suction cups and a second plurality of nubs which are evenly spaced around a perimeter of the second roller.

5. The skin treatment tool of claim 4, wherein the first roller comprises at least three suction cups and at least three nubs spaced around a perimeter of the first roller.

6. The skin treatment tool of claim 5, wherein each of the three suction cups are separated by at least one of the at least three nubs.

7. The skin treatment tool of claim 3, wherein six rotatable rollers are positioned around the handle.

8. The skin treatment tool of claim 1, wherein each of the first plurality of suction cups comprises a manually operated suction cup.

9. The massage roller device of claim 4, wherein the first roller includes a tine with extends substantially parallel to a longitudinal axis of the handle and the second roller includes a laterally facing opening which engages with the tine.

10. A massage roller device comprising:
a rigid elongated cylindrical body, and
a plurality of rotatable hubs positioned around the rigid elongated cylindrical body, each of the plurality of rotatable hubs having a first suction element and a first compression element, wherein the plurality of rotatable hubs are spaced apart along a longitudinal axis of the rigid elongated cylindrical body.

11. The massage roller device of claim 10, wherein the plurality of rotatable hubs comprises six rotatable hubs.

12. The massage roller device of claim 10, wherein each of the plurality of rotatable hubs has a plurality of suction elements and a plurality of compression elements extending outward from a surface thereof.

13. The massage roller device of claim 10, wherein the first suction element comprises a manually operated suction cup.

14. The massage roller device of claim 10, wherein the first compression element comprises a rigid plastic nub.

15. The massage roller device of claim 10, wherein the first suction element can be removed and replaced without requiring removal of one of the plurality of rotatable hubs from the rigid elongated cylindrical body.

16. The massage roller device of claim 10, wherein the first compression element can be removed and replaced without requiring removal of one of the plurality of rotatable hubs from the rigid elongated cylindrical body.

17. The massage roller device of claim 10, further comprising a first removeable handle connected to a first end of the rigid elongated cylindrical body.

18. The massage roller device of claim 17, further comprising a second removeable handle connected to a second end of the rigid elongated cylindrical body.

19. The massage roller device of claim 10, wherein at least a first hub of the plurality of rotatable hubs includes a laterally extending tine which extending into a laterally facing opening of a second hub of the plurality of rotatable hubs.

20. The massage roller device of claim 19, wherein the laterally facing opening is an elongated, curved slot.
